(19) United States
(12) Patent Application Publication
(10) Pub. No.: US 2018/0329374 A1
(43) Pub. Date: Nov. 15, 2018

(54) SYSTEMS AND METHODS FOR OPTIMIZING AN ENERGY STORAGE DEVICE CHARGING SCHEDULE

(71) Applicant: Microsoft Technology Licensing, LLC, Redmond, WA (US)

(72) Inventors: Conor Edmund KELLY, Leopardstown Heights (IE); Sean Michael James, Olympia, WA (US); Jennifer Carolan Goodward, Oakland, CA (US)

(21) Appl. No.: 15/595,118

(22) Filed: May 15, 2017

(51) Int. Cl. G05B 15/02; H02J 7/04; G05F 1/66; G06Q 10/04; G06Q 50/06; H02J 3/28

(52) U.S. Cl. CPC G05B 15/02; H02J 7/041; H02J 3/28; G06Q 10/04; G06Q 50/06; G05F 1/66

(57) ABSTRACT

Systems and methods for optimizing an energy storage device charging schedule are provided. In one example, a method may include calculating a merit value for a current time frame based on current data concerning predetermined criteria; calculating respective merit values for one or more future time frames based on the current data and historical data concerning the predetermined criteria; identifying, from among the current time frame and the one or more future time frames, a plurality of candidate charge adjustment time frames; and assigning, from among the plurality of candidate charge adjustment time frames, one or more charge adjustment time frames during which to adjust a charge level of an energy storage device based on at least the merit values associated with the plurality of candidate charge adjustment time frames.

### FIELD

The present disclosure relates to systems and methods for optimizing an energy storage device charging/discharging schedule based on predetermined criteria.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Electricity Markets are temporal by nature. Over time, their characteristics vary. A host of parameters define the current state of an electricity grid and its associated market including, but not limited to, energy prices ($/kWh), marginal emissions (i.e., the amount of carbon emissions for a battery per unit power delivered (gCO₂/kWh), demand (MW), and the power plants contributing.

Recent advances in battery storage technology and improving economics have introduced the possibility of storing power during more favorable times/states of a market, and discharging it later, during less favorable times on the market. However, identifying the optimal times to charge and discharge a battery to match a customer's requirements presents significant challenges.

### SUMMARY

In a feature, a system is provided. The system may include a processor, memory, and a charge adjustment application that is stored in the memory and executed by the processor. The charge adjustment application may be configured to calculate a merit value for a current time frame based on current data concerning one or more predetermined criteria. The charge adjustment application may further calculate respective merit values for one or more future time frames based on the current data and historical data concerning the one or more predetermined criteria. The charge adjustment application may identify, from among the current time frame and the one or more future time frames, a plurality of candidate charge adjustment time frames. The plurality of candidate charge adjustment time frames may include a plurality of sequential time frames associated with respective merit values satisfying a threshold merit value. Further, the charge adjustment application may assign, from among the plurality of candidate charge adjustment time frames, one or more charge adjustment time frames during which to adjust a charge level of an energy storage device based on at least the merit values associated with the plurality of candidate charge adjustment time frames.

In another feature, the charge adjustment application is further configured to generate an instruction to adjust the charge level of the energy storage device during the one or more charge adjustment time frames. In one example of this feature, the instruction to adjust the charge level includes an instruction to charge the energy storage device. In another example of this feature, the instruction to adjust the charge level includes an instruction to discharge the energy storage device. In still another example of this feature, the system further includes the energy storage device. In this example, the energy storage device is configured to adjust its charge level in response to receiving the instruction.

In one feature, the charge adjustment application is configured to assign the one or more charge adjustment time frames by calculating a charge capacity for each of the plurality of candidate charge adjustment time frames based on a length of time associated with each of the plurality of candidate charge adjustment time frames and a charge adjustment speed associated with the energy storage device.

In a feature, the charge adjustment application is configured to assign the one or more charge adjustment time frames by ranking the plurality of candidate charge adjustment time frames according to their respective merit values.

In another feature, the charge adjustment application is further configured to generate an instruction to maintain the charge level of the energy storage device during the current time frame.

In one feature, the one or more predetermined criteria include a plurality of criterion, each criterion being associated with a different weight.

In still another feature, the one or more predetermined criteria include at least two of the following criteria: energy cost; carbon emissions; and payment for grid services.

In a feature, a method for optimizing an energy storage device charging/discharging schedule based on predetermined criteria is provided. The method may include calculating a merit value for a current time frame based on current data concerning one or more predetermined criteria. Respective merit values for one or more future time frames may be calculated based on the current data and historical data concerning the one or more predetermined criteria. Further, a plurality of candidate charge adjustment time frames may be identified from among the current time frame and the one or more future time frames. The plurality of candidate charge adjustment time frames includes a plurality of sequential time frames associated with respective merit values satisfying a threshold merit value. One or more charge adjustment time frames during which to adjust a charge level of an energy storage device may be assigned from among the plurality of candidate charge adjustment time frames. The assignment may be based on at least the merit values associated with the plurality of candidate charge adjustment time frames. In addition, the method may include generating an instruction to adjust the charge level of the energy storage device during the one or more charge adjustment time frames.

In one feature, generating the instruction to adjust the charge level may include generating an instruction to charge the energy storage device.

In another feature, generating the instruction to adjust the charge level may include generating an instruction to discharge the energy storage device.

In a feature, the method may further include adjusting the charge level of the energy storage device during the one or more charge adjustment time frames.

In still another feature, assigning the one or more charge adjustment time frames may include calculating a charge capacity for each of the one or more charge adjustment time frames based on a length of time associated with each of the plurality of candidate charge adjustment time frames and a charge adjustment speed associated with the energy storage device.

In one feature, assigning the one or more charge adjustment time frames may include ranking the plurality of candidate charge adjustment time frames according to their respective merit values.

In another feature, the method may further include generating an instruction to maintain the charge level of the energy storage device during the current time frame.

In a feature, the predetermined criteria may include a plurality of criterion, each criterion being associated with a different weight.

In still another feature, the predetermined criteria may include at least two of the following criteria: energy cost; carbon emissions; and payment for grid services.

In one feature, a data center is provided. The data center may include a charging window identification module, a charge adjustment time frame assignment module, and an energy storage device operatively connected to the charge adjustment time frame assignment module. The charging window identification module may be configured to identify, from among a current time frame associated with a merit value and one or more future time frames associated with respective one or more merit values, a plurality of candidate charge adjustment time frames. The plurality of candidate charge adjustment time frames may include a plurality of sequential time frames associated with respective merit values satisfying a threshold merit value. The charge adjustment time frame assignment module may be configured to assign, from among the plurality of candidate charge adjustment time frames, one or more charge adjustment time frames during which to adjust a charge level of an energy storage device based on at least the merit values associated with the plurality of candidate charge adjustment time frames. In addition, the charge adjustment time frame assignment module may be configured to generate an instruction to adjust the charge level of the energy storage device during the one or more charge adjustment time frames. The energy storage device may be configured to adjust its charge level in response to receiving the instruction.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an energy storage device system according to principles of the present disclosure.

FIG. 2 is a functional block diagram of a computing device for controlling one or more energy storage devices according to principles of the present disclosure.

FIG. 3 is a functional block diagram of a charge adjustment device for controlling one or more energy storage devices according to principles of the present disclosure.

FIG. 4 is a bar graph illustrating merit values for charging/discharging one or more energy storage devices over time according to principles of the present disclosure.

FIG. 5 is a bar graph illustrating merit values for charging/discharging one or more energy storage devices over time according to principles of the present disclosure.

FIG. 6 is a bar graph illustrating merit values for charging/discharging one or more energy storage devices over time according to principles of the present disclosure.

FIG. 7 is a flow diagram illustrating a method for optimizing an energy storage device charging/discharging schedule based on predetermined criteria according to principles of the present disclosure.

FIGS. 8a-8c are a flow diagram illustrating a method for optimizing an energy storage device charging/discharging schedule based on predetermined criteria according to principles of the present disclosure.

In the drawings, reference numbers may be reused to identify similar and/or identical elements.

### DESCRIPTION

Below are simplistic examples of a distributed computing environment in which the systems and methods of the present disclosure can be implemented. Throughout the description, references to terms such as servers, client devices, applications and so on are for illustrative purposes only. The terms servers and client devices are to be understood broadly as representing computing devices comprising one or more processors and memory configured to execute machine readable instructions. The terms applications and computer programs are to be understood broadly as representing machine readable instructions executable by the computing devices.

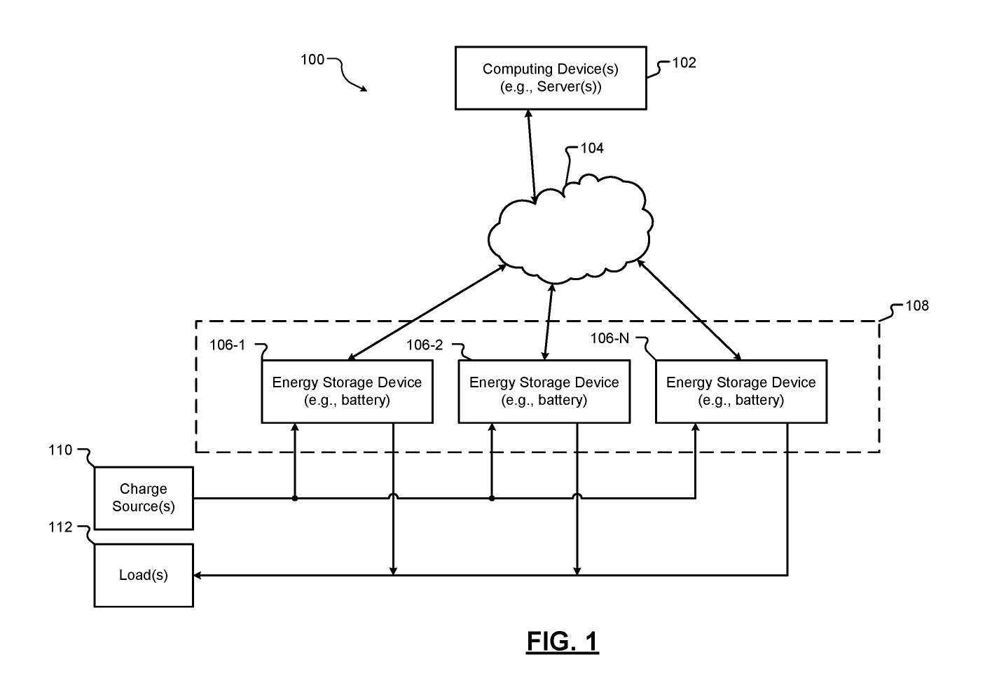

FIG. 1 shows a simplified example of a distributed network system 100. The distributed network system 100 includes a network 104, one or more computing devices 102 (e.g., one or more servers), an array of energy storage devices 108 (e.g., batteries) including one or more energy storage devices 106-1, 106-2, . . . , and 106-N (collectively energy storage devices 106) (where N is an integer greater than or equal to one), one or more charge sources 110, and one or more loads 112.

The network 104 may include a local area network (LAN), a wide area network (WAN) such as the Internet, or other type of network (collectively shown as the network 104). While only one computing device 102 is shown, the distributed network system 100 may include multiple computing devices. For example, the computing device(s) 102 may be located at different geographical locations. The energy storage device(s) 106 communicate with the computing device(s) 102 via the network 104. The energy storage device(s) 106 and the computing device(s) 102 may connect to the network 104 using wireless and/or wired connections.

In operation, and as discussed in additional detail below, the computing device(s) 102 calculate optimal time frames for charging and discharging the energy storage device(s) 106 utilizing machine learning techniques and customizable, predefined criteria. The computing device(s) 102 generate instructions instructing the energy storage device(s) 106 when to charge and discharge. The instructions are communicated over the network 104. In accordance with the received instructions, the energy storage device(s) 106 obtain charge from one or more charge sources 110, or discharge to the load(s) 112. In one example, the computing device(s) 102 are utilized to control energy storage devices 106 in a high energy use facility, such as a data center.

In some examples, the charge source(s) 110 may include a utility company, generator(s), solar panel(s), wind turbine(s), or the like that supply electric charge to the energy storage devices 106. In some examples, the load(s) may include computers (e.g., server computers), cooling systems, pumps, fans, routing systems, heat exchange systems, etc. that receive electric charge from the energy storage devices 106.

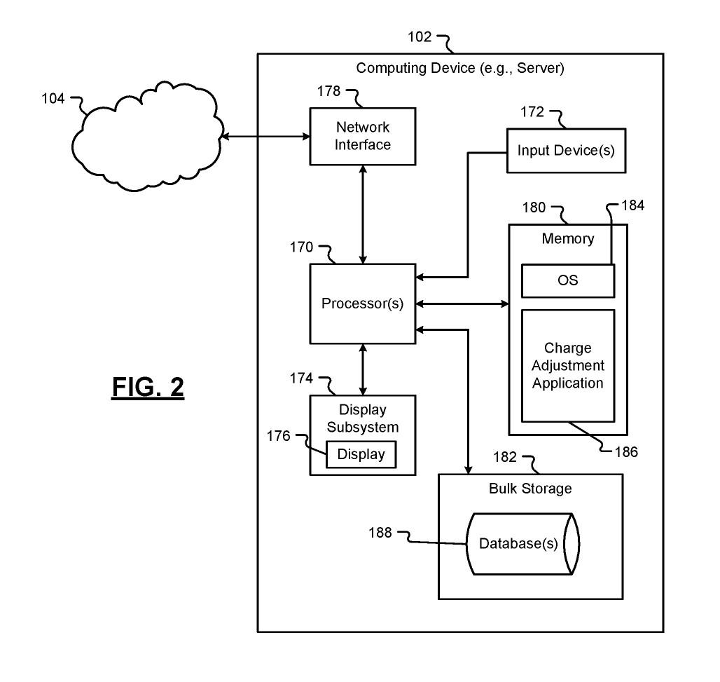

FIG. 2 shows an example of a computing device 102. For simplicity, only a single computing device 102 is depicted in FIG. 2, however, it is understood that the distributed network system 100 of FIG. 1 may include one or more computing devices 102 adopting the same or a similar architecture to that set forth with regard to the computing device 102 of FIG. 2. In one example, the computing device 102 is a server computer. The computing device 102 typically includes one or more CPUs or processors 170, one or more input devices 172 (e.g., a keypad, touchpad, mouse, and so on), a display subsystem 174 including a display 176, a network interface 178, a memory 180, and a bulk storage 182.

The network interface 178 connects the computing device 102 to the distributed network system 100 via the network 104. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more hard disk drives (HDDs), or other bulk storage device.

The processor 170 of the computing device 102 executes an operating system (OS) 184 and a charge adjustment application 186 configured to assign one or more charge adjustment time frames to one or more energy storage devices as discussed in additional detail below. The bulk storage 182 may store one or more databases 188 that store data structures used by the charge adjustment application 186 to perform respective functions. In one example, the computing device 102 may be utilized to control energy storage devices (e.g., the energy storage devices 106 illustrated in FIG. 1) in a high energy use facility, such as a data center.

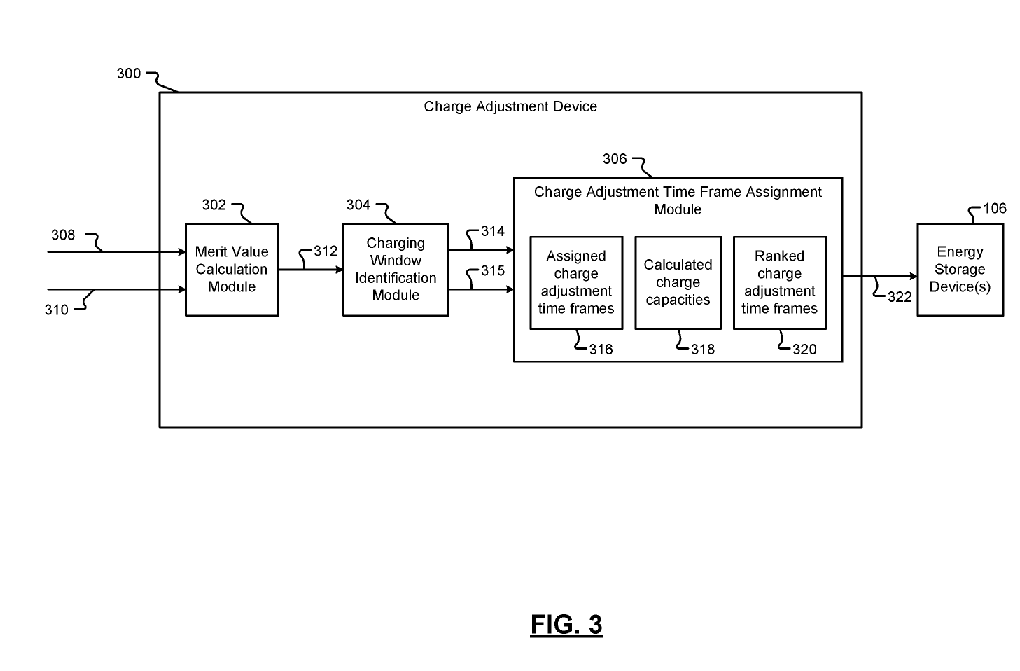

Referring now to FIG. 3, a charge adjustment device 300 for controlling one or more energy storage devices 106 is shown. In one example, the charge adjustment device 300 may be implemented as a computing device, such as the computing device 102 described with regard to FIG. 2 above, executing the charge adjustment application 186. Similarly, the charge adjustment device 300 may be communicatively connected to the energy storage device(s) 106 via a network, such as the network 104 described above with regard to FIGS. 1-2. In one example, the charge adjustment device 300 may be utilized to control energy storage devices 106 in a high energy use facility, such as a data center.

The charge adjustment device 300 includes a merit value calculation module 302, a charging window identification module 304, and a charge adjustment time frame assignment module 306. The charge adjustment device 300 is configured to operate as follows.

The merit value calculation module 302 is configured to obtain (i.e., fetch or receive) current data 308 concerning one or more predetermined criteria and historical data 310 concerning the one or more predetermined criteria. The current data 308 reflects current (i.e., present time) values for the predetermined criteria, while the historical data 310 reflects historical (i.e., past) values for the predetermined criteria. The merit value calculation module 302 is configured to calculate (i) a merit value for a current time frame based on the current data 308 and (ii) respective merit values for one or more future time frames based on the current data 308 and the historical data 310. In some examples, a polynomial regression predictive machine learning model is utilized to calculate merit values associated with future time frames based on the historical data 310 and current data 308. In some examples, the polynomial regression predictive machine learning model may utilize weather forecasts and associated time of day/year values to calculate the respective merit values for one or more future time frames.

The merit values 312 describe the desirability of making a charge adjustment to one or more energy storage devices during a particular time frame. For example, a merit value may indicate that one or more energy storage devices should be charged during a given time frame. Alternatively, a merit value may indicate that the one or more energy storage devices should be discharged during a given time frame. Further still, a merit value may indicate that the one or more energy storage devices should maintain a charge level (i.e., neither charge nor discharge) during a given time frame.

The merit value calculation module 302 is configured to calculate the merit values 312 based on predetermined—and in some examples weighted—criteria. The criteria relied upon, and the weighting of those criterion (if any), is customizable based on user preference. Example criteria that may be relied upon in calculating the merit values 312 can include, but is not limited to, energy prices ($/kWh), marginal emissions (i.e., the amount of carbon emissions for an energy storage device per unit power delivered (gCO₂/kWh)), demand (MW), and/or payment for grid services (i.e., the current value or predicted value payments tied to the utilization of energy storages devices to provide grid services at the wholesale or distribution level). In addition, each criterion of the predetermined criteria may be associated with a weight. In this manner, the merit value calculation module 302 is configured to take into account both the type(s) of predetermined criteria being relied upon, as well as the weight given to each criterion, in calculating the merit values 312 for the time frames.

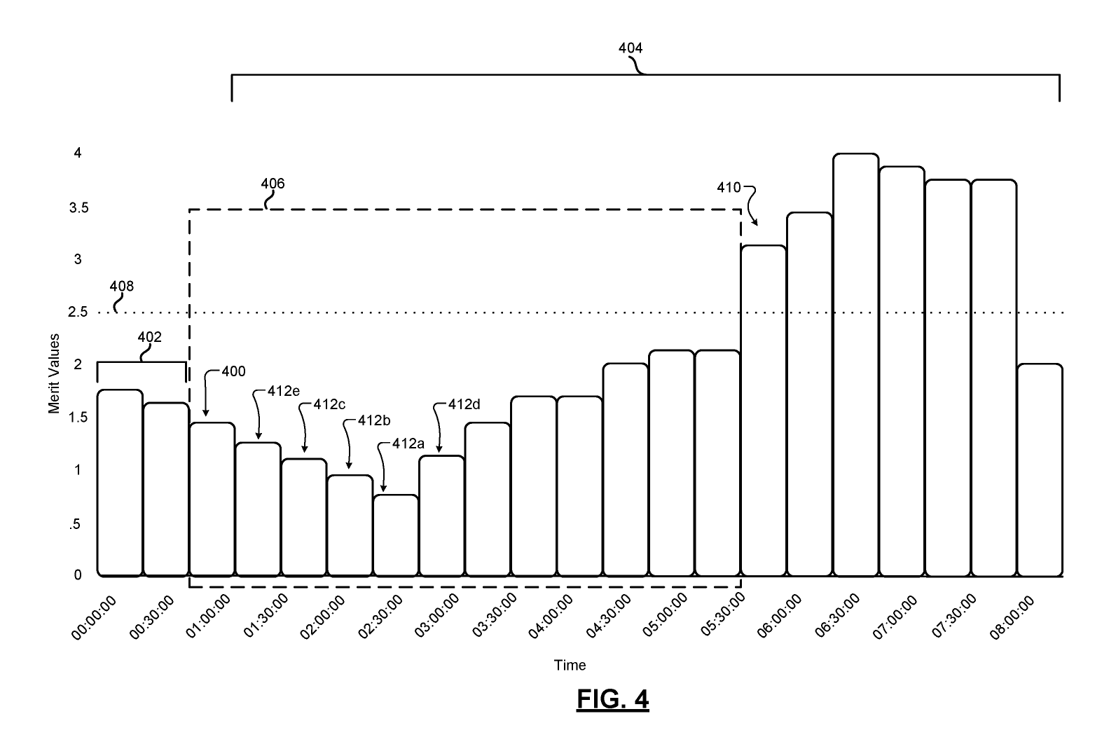

The charging window identification module 304 is configured to obtain the merit values 312 and identify a charging window therefrom. More specifically, the charging window identification module 304 is configured to identify a charging window by identifying, from among the current time frame and one or more future time frames, a plurality of candidate charge adjustment time frames 314 based on the merit values 312. The plurality of candidate charge adjustment time frames 314 includes a plurality of sequential time frames associated with respective merit values satisfying a threshold merit value. Additional details concerning identification of the charging window by the charging window identification module 314 are set forth with regard to FIG. 4 below.

The charge adjustment time frame assignment module 306 is configured to obtain the plurality of candidate charge adjustment time frames 314, along with the respective merit values 315 associated with the plurality of candidate charge adjustment time frames 314, from the charging window identification module 304 and assign one or more charge adjustment time frames 316 therefrom. The assigned one or more charge adjustment time frames 322 specify the time frame(s) during which a charge level of the energy storage device 106 should be adjusted.

More specifically, the charge adjustment time frame assignment module 306 is configured to assign the one or more charge adjustment time frames 316 from among the candidate charge adjustment time frames 314. The assignment of the one or more charge adjustment time frames 316 from the candidate charge adjustment time frames 314 may be based on at least the merit values 315 associated with the plurality of candidate charge adjustment time frames 314, as discussed in greater detail with regard to FIG. 4 below.

In one example, the charge adjustment time frame assignment module 306 is configured to assign the one or more charge adjustment time frames 316 based on calculated charge capacities 318. In this example, the charge adjustment time frame assignment module 306 is configured to calculate a charge capacity for each of the candidate charge adjustment time frames 314 based on a length of time associated with each of the plurality of candidate charge adjustment time frames 314 and a charge adjustment speed associated with the energy storage device 106. The charge adjustment speed indicates how fast a given energy storage device may be charged or discharged.

In another example, the charge adjustment time frame assignment module 306 is configured to assign the one or more charge adjustment time frames 316 based on ranked charge adjustment time frames 320. In this example, the charge adjustment time frame assignment module 306 is configured to rank the plurality of candidate charge adjustment time frames 314 according to their respective merit values.

The charge adjustment time frame assignment module 306 is further configured to generate an instruction 322 to adjust the charge level of the energy storage device 106 during the one or more assigned charge adjustment time frames 316. In one example, the instruction 322 includes an instruction to charge the energy storage device 106. In another example, the instruction includes an instruction to discharge the energy storage device 106. In still another example, the instruction 322 includes an instruction to maintain the charge level of the energy storage device (e.g., during a current time frame). The energy storage device 106 is configured to adjust its charge level in response to receiving the instruction 322.

Turning now to FIG. 4, a bar graph illustrating merit values for charging/discharging one or more energy storage devices over time according to principles of the present disclosure is provided. The graph illustrates a plurality of time frames, including a current time frame 400, a plurality of past time frames 402, and a plurality of future time frames 404. Each time frame is associated with a length of time (shown along the x-axis) and a merit value (shown along the y-axis).

While the time frames of FIG. 4 are shown having the same length, it is understood that the frames could be associated with different lengths of time without deviating from the teachings of the present disclosure. The merit values associated with the time frames may be calculated according to the procedure for calculating merit values described above. Further, the specific merit values and time frames set forth in FIG. 4 are provided merely for illustrative purposes and other suitable merit values and time frames may be utilized without departing from the teachings of the present disclosure.

In particular, FIG. 4 illustrates one example method of assigning one or more charge adjustment time frames during which to adjust a charge level of an energy storage device. The method may be carried out, in one example, by the charge adjustment application 186 described above with regard to FIG. 2. Following the calculation of the merit values associated with the past time frames 402, current time frame 400, and future time frames 404, a charging window 406 is identified.

The charging window 406 is identified from among the current time frame 400 and the future time frames 404, and encompasses a plurality of candidate charge adjustment time frames from which the actual charge adjustment time frames may be assigned. The plurality of candidate charge adjustment time frames (which, collectively, constitute the charging window 406) may be identified by identifying sequential future time frames following the current charge frame 400 that satisfy a threshold merit value 408.

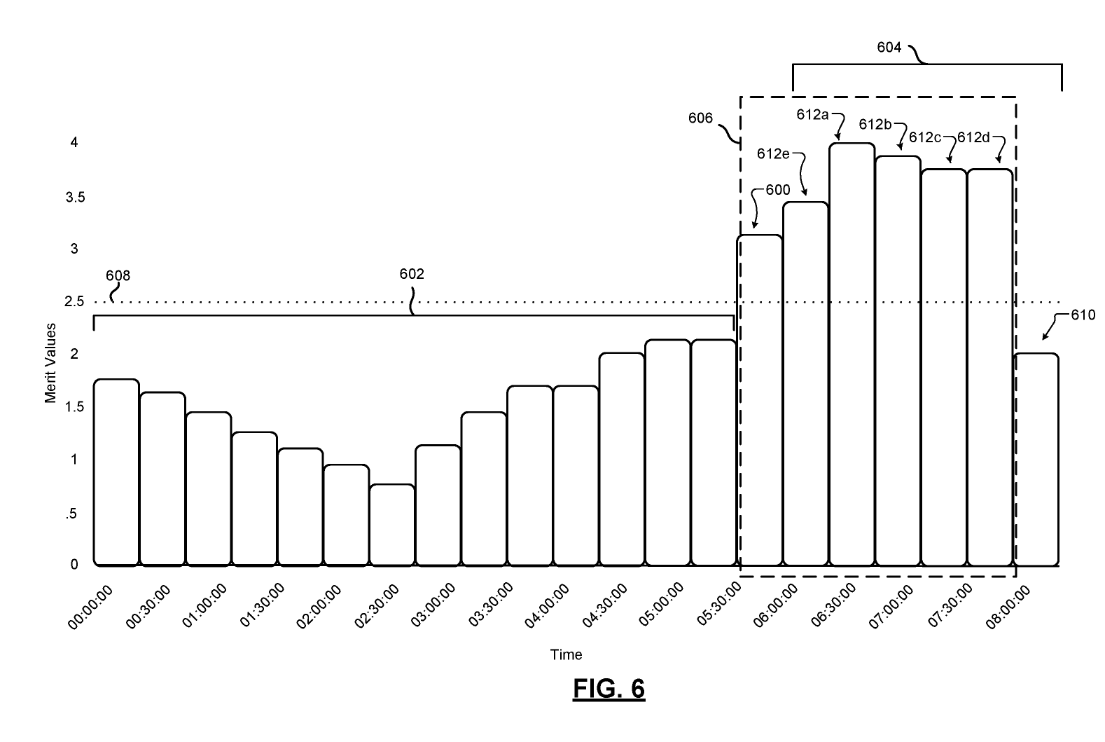

In the example shown in FIG. 4, the threshold merit value 408 is 2.5, and only time frames associated with merit values at or below 2.5 are deemed to satisfy the threshold merit value. However, in other examples (see FIG. 6), only time frames associated with merit values at or above the threshold merit value are deemed to satisfy the threshold merit value. The selection of the threshold merit value (e.g., threshold merit value 408) and the conditions under which it is satisfied are matters of design choice, and any suitable merit value and satisfaction criteria may be employed without deviating from the teachings of the present disclosure. As shown in FIG. 4, future time frame 410 is not included within the charging window 406 because it is associated with a merit value that exceeds the threshold merit value 408 (and, thus, does not satisfy the merit value according to this example). Thus, future time frame 410 serves as the “cut-off” point for the charging window 406 depicted in FIG. 4.

The one or more charge adjustment time frames may be assigned from among the plurality of candidate charge adjustment time frames encompassed within the charging window 406 according to the following method. Recognizing that in some examples the merit values may be calculated based on a plurality of weighted criterion, for simplicity, the following example assumes the merit values reflect one criterion: energy price. Accordingly, the goal of the method illustrated in FIG. 4 is to identify, from among the current time frame 400 and the future time frames encompassed with the charging window 406, the optimal times frames during which to charge the energy storage device, so as to minimize cost.

The method begins by ranking the time frames within the charging window 406 according to their respective merit values. Future time frame 412a is identified as the best frame because it is associated with the lowest merit value (correlating to the lowest price for energy in this example). Time frame 412b is identified as the second best, time frame 412c as the third best, time frame 412d as the fourth best, time frame 412e as the fifth best, etc. until all time frames within the charging window 406 are ranked according to their respective merit values.

Next, the method assigns time frames during which to charge the energy storage device based on the merit values associated with the times frames, the length of the time frames, the energy storage capacity of the energy storage device, and the charge adjustment speed of the energy storage device (i.e., the rate at which the energy storage device may be charged or discharged, as the case may be).

For example, the method may include calculating a charge capacity for time frame 412a. The charge capacity reflects how much of the energy storage device's charge capacity can be filled during the time frame at issue (e.g., time frame 412a). The charge capacity for a given time frame is the product of the length of the time frame and the charge adjustment speed associated with the energy storage device. Thus, in an example where the time frame 412a is 30 minutes in length and the charge adjustment speed of the energy storage device is 2 MW, 1 MWh may be assigned to time frame 412a.

Further assume, for purposes of this example, that (1) the energy storage device sought to be charged is presently completely devoid of charge (i.e., empty) and (2) the total capacity for the energy storage device is 5 MWh. Accordingly, after assigning 1 MWh to time frame 412a, the energy storage device includes 4 MWh of unassigned storage capacity. Thus, the method continues assigning time frames from within the charging window 406 until the full charge capacity of the energy storage device has been assigned.

In this example, where all of the candidate charge adjustment time frames are presented as having equal lengths, and the charge adjustment speed of the energy storage device is a constant 2 MW, the following time frames may be assigned in the following order to ensure that all of the charge capacity for the energy storage device has been assigned from within the charging window so as to minimize cost: (1) 412a; (2) 412b; (3) 412c; (4) 412d; and (5) 412e.

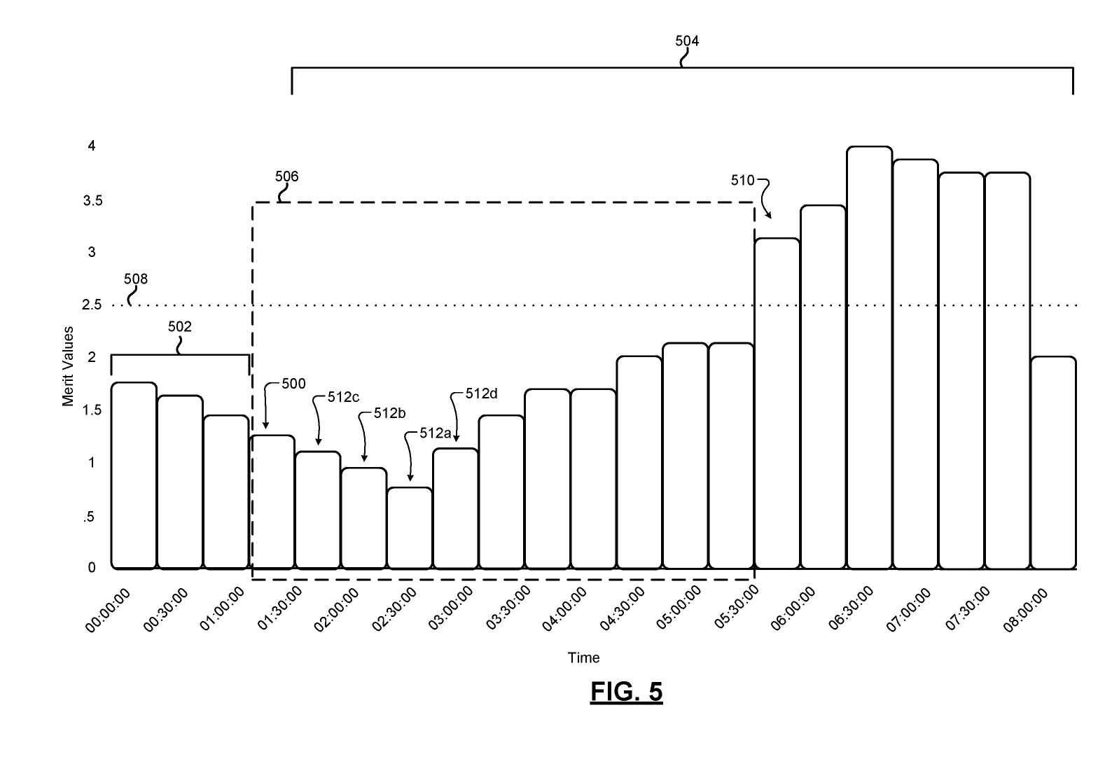

Notably, the current time frame 400 is not assigned as a charge adjustment time frame according to this example because the full charge capacity of the energy storage device was assigned utilizing time frames associated with superior merit values than the current time frame 400. As discussed with regard to FIG. 5 below, the foregoing method is iterative, and may be re-run for each new current time frame so as to assess whether to charge/discharge an energy storage device during a current time frame, or wait for more favorable time frames.

FIG. 5 illustrates the method of FIG. 4 being applied during a new current time frame 500. The merit values associated with the various time frames remain the same between FIGS. 4 and 5. FIG. 5 merely represents a later point in time than FIG. 4, where the current frame 400 of FIG. 4 is now included within the past frames 502 of FIG. 5. Thus, the graph of FIG. 5 illustrates a plurality of time frames, including a current time frame 500, a plurality of past time frames 502, and a plurality of future time frames 504. The charging window 506 encompasses the current frame 500 and several, sequential future frames 504 (e.g., future frames 512c, 512b, 512a, 512d, etc.), and culminates before future frame 510, which is associated with a merit value that does not satisfy the threshold merit value 508 according to this example.

Recall that in the example set forth in FIG. 4, the determination was made to not assign the current time frame 400 as a charge adjustment time frame because other, future, time frames within the charging window 406 represented superior options. FIG. 5 illustrates an example where the current time frame 500 is assigned as a charge adjustment time frame.

More specifically, the method of assigning, from among the plurality of candidate charge adjustment time frames encompassed within the charging window 506, the one or more charge adjustment time frames continues in accordance with the procedure described with regard to FIG. 4. However, in FIG. 5, the current frame 500 is determined to represent the fifth best time frame for charging the energy storage device based on its merit value (behind time frames 512a, 512b, 512c, and 512d—in that order). Accordingly, the foregoing method may be iteratively applied for each new current time frame to assign the optimal time frames for charging/discharging an energy storage device.

FIG. 6 illustrates the method of FIGS. 4-5 being applied during a new current time frame 600. The merit values associated with the various time frames remain the same between FIGS. 4-6. FIG. 6 merely represents a later point in time than FIG. 5, where the current frame 500 of FIG. 5 is now included within the past frames 602 of FIG. 6. Thus, the graph of FIG. 6 illustrates a plurality of time frames, including a current time frame 600, a plurality of past time frames 602, and a plurality of future time frames 604. The charging window 606 encompasses the current frame 600 and several, sequential future frames 604 (i.e., future frames 612e, 612a, 612b, 612c, and 612d), and culminates before future frame 610, which is associated with a merit value that does not satisfy the threshold merit value 608 according to this example.

The key distinction between FIGS. 4-5 and FIG. 6 is that FIG. 6 illustrates the process for assigning optimal time frames during which to discharge an energy storage device. Thus, in keeping with the example where the merit values correlate to energy prices, the goal is to discharge the energy storage device during time frames associated with the highest energy prices so as to yield maximum returns. Stated differently, whereas in FIGS. 4-5 the threshold merit values 408, 508 set a ceiling and the goal was to identify the optimal time frames associated with merit values at or below the ceiling, in FIG. 6, the threshold merit value 608 sets a floor and the goal is to identify optimal times frames associated with merit values at or above the floor.

Thus, and keeping with the process described above with regard to FIGS. 4-5, a charging window 606 is identified that encompasses the current time frame 600 and a plurality of sequential, future time frames (i.e., future time frames 612e, 612a, 612b, 612c, and 612d) associated with respective merit values satisfying the threshold merit value 608. The candidate charge adjustment time frames (i.e., frames 600, 612e, 612a, 612b, 612c, and 612d) are ranked according to their respective merit values. Again, in the example shown in FIG. 6, the goal is to identify the optimal time frames during which to discharge the energy storage device so as to maximize returns.

Consequently, the following charge adjustment time frames are assigned according to the following order: (1) 612a; (2) 612b; (3) 612c; (4) 612d; and (5) 612e. Yet again, this assumes that the energy storage device has 5 MWh of charge to discharge, and 1 MWh of charge may be discharged during each of the foregoing time frames. Notably, current frame 600 is not assigned as a charge adjustment time frame according to this example because it reflects an inferior time frame as compared to frames 612a, 612b, 612c, 612d, and 612e. As with the process for identifying optimal time frames during which to charge the energy storage device (see FIGS. 4-5), the process for identifying optimal time frames during which to discharge the energy storage device may continue iteratively for each new current time frame.

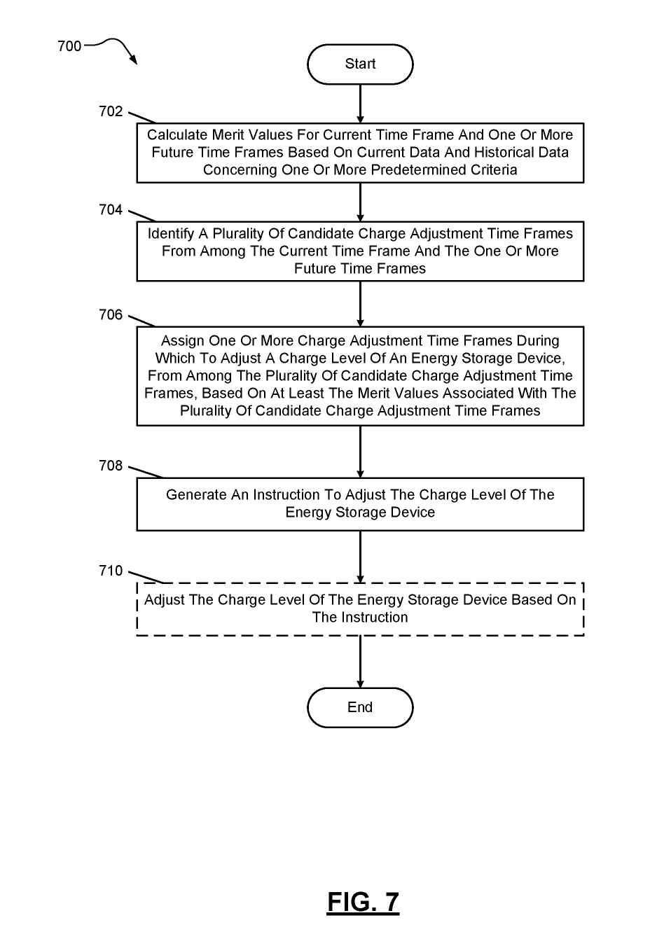

Referring now to FIG. 7, a flow diagram illustrating a method 700 for optimizing an energy storage device charging/discharging schedule according to principles of the present disclosure is provided. The method 700 begins at 702 where merit values are calculated for a current time frame and one or more future time frames. The merit value for the current time frame may be calculated based on current data concerning one or more predetermined criteria. The respective merit values for the one or more future time frames may be calculated based on the current data and historical data concerning the one or more predetermined criteria.

At 704, a plurality of candidate charge adjustment time frames are identified from among the current time frame and the one or more future time frames. The plurality of candidate charge adjustment time frames includes a plurality of sequential time frames associated with respective merit values satisfying a threshold merit value.

At 706, one or more charge adjustment time frames are assigned from among the plurality of candidate charge adjustment time frames. The one or more charge adjustment time frames reflect time frames during which to adjust a charge level of an energy storage device. The one or more charge adjustment time frames may be assigned based on at least the merit values associated with the plurality of candidate charge adjustment time frames.

At 708, an instruction is generated to adjust the charge level of the energy storage device. In one example, the instruction may include an instruction to charge the energy storage device. In another example, the instruction may include an instruction to discharge the energy storage device.

At optional 710, a charge level of the energy storage device is adjusted. The charge level may be adjusted based on, or in response to, the instruction generated at 708. Following 710, the method 700 concludes.

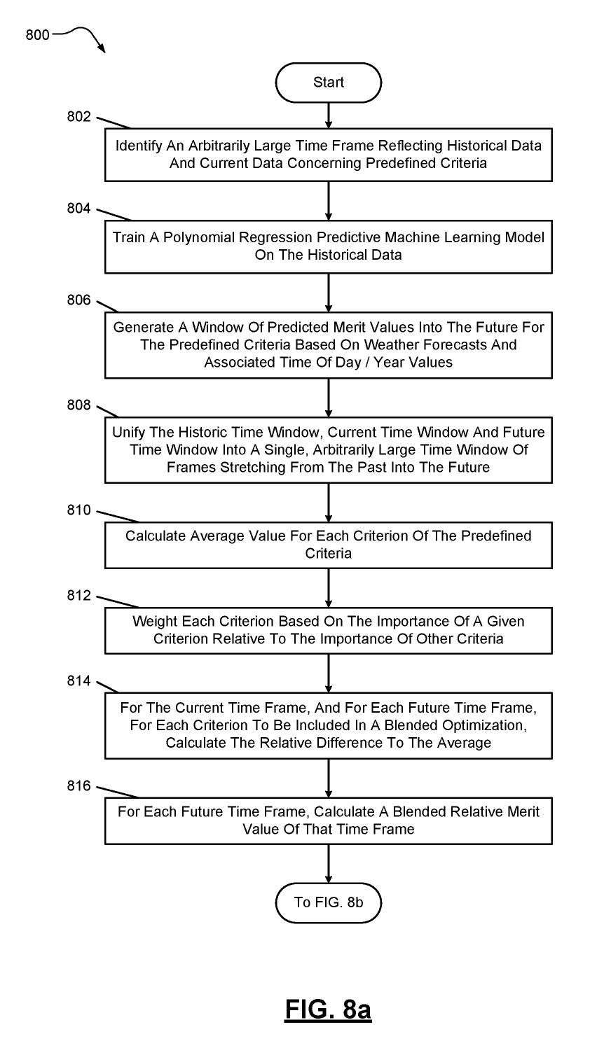

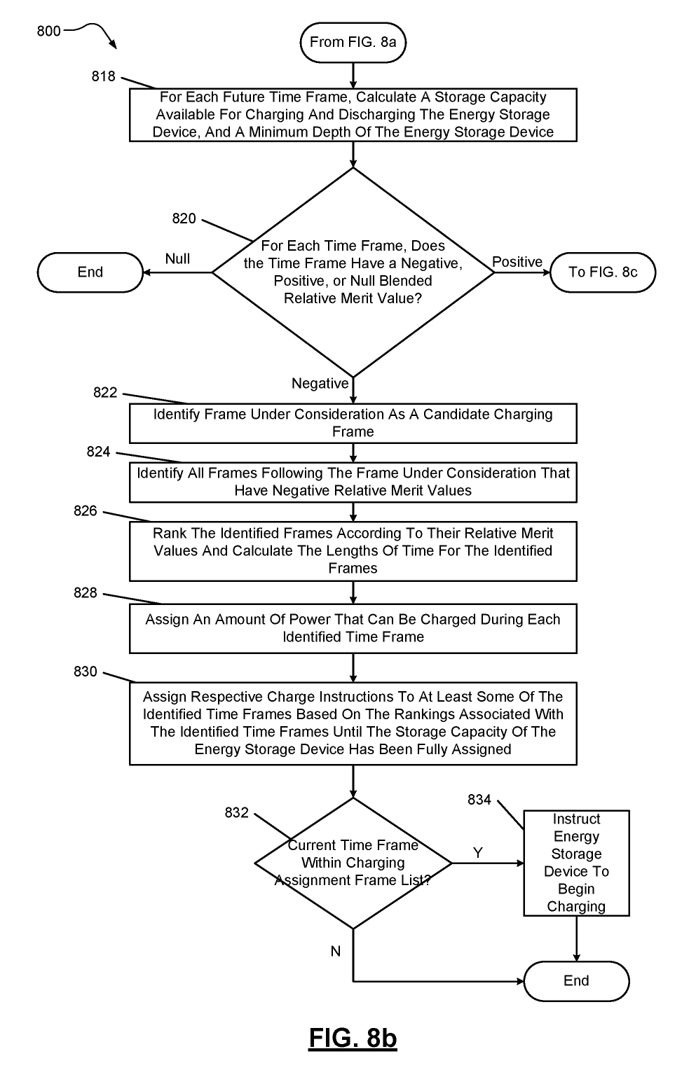

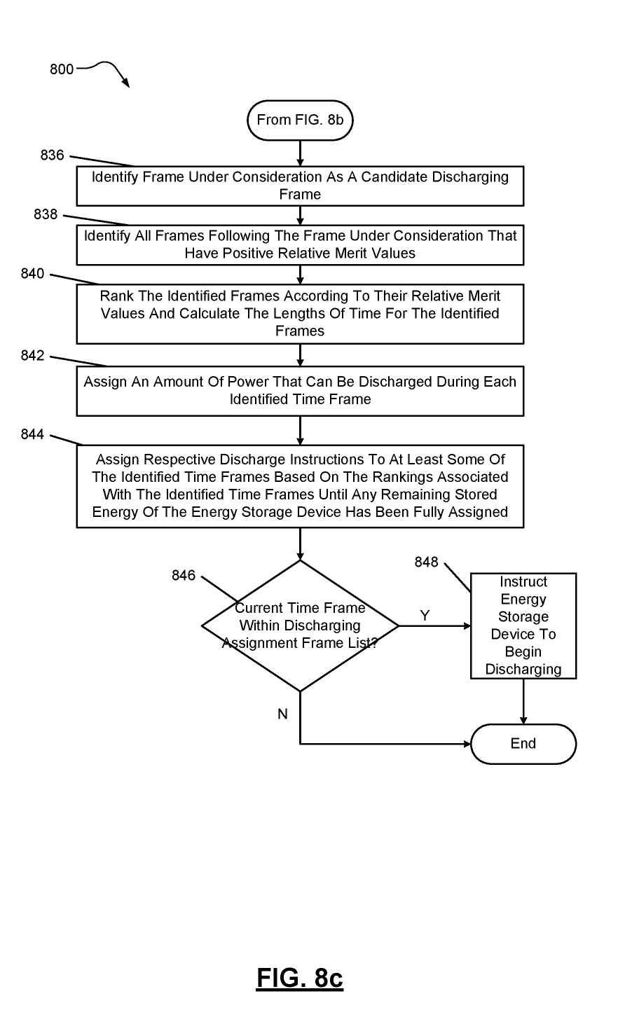

Referring now to FIGS. 8a-8c, a flow diagram illustrating another method 800 for optimizing an energy storage device charging/discharging schedule according to principles of the present disclosure is provided. The method begins at 802 where an arbitrarily large time frame is identified reflecting historical data and current data concerning predefined criteria. At 804, a polynomial regression predictive machine learning model is trained on the historical data concerning the predefined criteria. At 806, a window of predicted merit values is generated into the future for the predefined criteria based on weather forecasts and associated time of day/year values.

At 808, the historic time window, current time window, and future time windows are unified into a single, arbitrarily large time window of frames stretching from the past into the future. At 810, average values are calculated for each criterion of the predefined criteria. At 812, each criterion is weighted based on the importance of a given criterion relative to the importance of other criteria. The weight given to each criterion may be defined as:

$${Weight}_{n} = \frac{{Criterion}_{n}}{{\sum }_{k = 1}^{n} {Criterion}_{k}} \qquad ( 1 )$$

At 814, relative differences to the average are calculated, for the current and future time frames, for each criterion to be included as part of a blended optimization. More specifically, the relative differences to the average is a measure of (1) whether the value of a given criterion is “better” or “worse” than average, and how much “better” or “worse” it is, as reflected by the following formula:

ΔCriteriaₙ₌μ(Criteria_{1..n})−Criteriaₙ (2)

At 816, a blended relative merit value is calculated for each future time frame. The blended relative merit value for a given future time frame may be calculated by adding the individual criterion relative ratings, weighted by their normalized criterion weighting as defined by:

φframe=Σₖ₌₁ⁿ(Weightₙ×ΔCriteriaₙ) (3)

Continuing to FIG. 8b, at 818, a storage capacity available for charging and discharging the energy storage device is calculated for each future time frame. In addition, at 818, a minimum depth of the energy storage device is calculated. In some examples, the storage capacity and minimum depth may be calculated according to the following:

Total Usable Storage Capacity=TotalStorage×StorageHealth as a function of 100%:

StorageCapacity_{Usable}=StorageCapacityₜₒₜₐₗ×AvailableHealthyStoragePercentage (4)

Predict the Underlying Load (for illustration here, a Data Center Load):

Load_{DataCenter}_{_}_{Predicted}=Pred(DataCenterLoadIndicatorVariables) (5)

Reserve Storage Capacity=Predicted DataCenter Load×Generator Start and Sync Time:

StorageCapacity_{Reserve}=StartTime_{Generator}×Load_{DataCenter}_{_}_{Predicted} (6)

Storage Capacity available for monitisation=Usable Storage Capacity−Reserve Storage Capacity:

StorageCapacitty_{Available}=StorageCapacity_{Usable}−StorageCapacity_{Reserve} (7)

StorageCapacity_{MinimumDischargeDepth}=StorageCapacity_{Usable}−StorageCapacity_{Available} (8)

If there is no critical demand powered by the energy storage device, then:

StorageCapacity_{Available}=StorageCapacity_{Usable} (9)

StorageCapacity_{MinimumDischargeDepth}=0 (10)

Returning to FIG. 8b, at 820, a determination is made as to whether each time frame has a negative, positive, or null blended relative merit value. If a given time frame has a null blended relative merit value, it is not identified as a candidate charging/discharging frame and the method 800 may end as to that frame. However, if a given time frame is determined to have a positive blended relative merit value, the method 800 continues to FIG. 8c. If a given time frame is determined to have a negative blended relative merit value, the method 800 proceeds to 822.

At 822, the time frame under consideration is identified as a candidate charging frame based on its negative blended relative merit value:

$${ϕ}_{frame} {⇒}_{\leq 0} Potential Charging Frame \qquad ( 11 )$$

Because of the negative blended relative merit value, the time frame under consideration is determined to be “better” than average. However, there may be even “better” time frames in the future during which the energy storage device could be charged (e.g., prices may fall further before they increase above average, in an example where the only predetermined criterion is energy price).

At 824, all time frames following the time frame under consideration having negative blended relative merit values are identified. At 826, the identified time frames are ranked according to their blended relative merit values (e.g., best, second best, etc.) and the lengths of time for the identified time frames are calculated. At 828, an amount of power that can be charged during each identified time frame is assigned (time in hours of the time frame window * (i.e., multiplied by) maximum charging rate of the energy storage device).

At 830, respective charge instructions are assigned to at least some of the identified time frames based on the rankings associated with the identified times frames until the storage capacity of the energy storage device has been fully assigned. In one example, 830 may entail, starting with the lowest (e.g., “best”) blended relative merit value, assigning a charge instruction to that time frame until the available capacity of the energy storage device has been accounted for.

At 832, a determination is made as to whether the current time frame is within the charging assignment frame list (i.e., among the list of time frames assigned charge instructions). If so, the method 800 proceeds to 834 and the energy storage device is instructed to begin charging with the calculated charging rate according to the following:

| | | |
|---|---|---|
| a. | | While(StorageCapacity_{Assigned} < StorageCapacity_{Available}) |
| | | { |
| | i. | If Storage Capacity Available (kWh) exceeds the Max Charge Rate (kW) × the |

duration of the frame (h), then ChargeRate assigned is the Max charge rate of the
storage device. Otherwise, there is less capacity avialable, so the highest charge rate
is assigned without exceeding the Available Storage Capacity.

| | 1. | if(ChargeRate_{kW} × TimeDuration_{frame}) > (StorageCapacity_{Available} − StorageCapacity_{Assigned}) | |
|---|---|---|---|
| | | 1. | $\{ {ChargeRate}_{kW} = \frac{( {StorageCapacity}_{Availiable} - {StorageCapacity}_{Assigned} )}{ChargeRate\_MaxkW}$ |
| | 2. | Else { [symbol] ChrgeRate [symbol] _kW = [symbol] ChrgeRate [symbol] _Max [symbol] } | |
| ii. | ChargeRate_{frame} = ChargeRate_{kW} | | |
| iii. | StorageCapacity_{Assigned} += ChargeRate_{frame} × TimeDuration_{frame} | | |
| | } | | |

If the current time frame is not within the charging assignment frame list, the method 800 concludes. In some examples, upon a determination that the current time frame is not within the charging assignment frame list, the energy storage device may remain idle (i.e., neither charge nor discharge) during the current time frame.

Upon a determination at 820 of FIG. 8b that a given time frame has a positive blended relative merit value, the method 800 proceeds to 836 of FIG. 8c. At 836, the time frame under consideration is identified as a candidate discharging frame based on its positive blended relative merit value:

$${ϕ}_{frame} {⇒}_{> 0} Potential Discharging Frame \qquad ( 12 )$$

Because of the positive blended relative merit value, the time frame under consideration is determined to be “worse” than average. However, there may be even “worse” time frames in the future during which the energy storage device could be discharged (e.g., prices may increase further before they decrease below average, in an example where the only predetermined criterion is energy price).

At 838, all time frames following the time frame under consideration having positive blended relative merit values are identified. At 840, the identified time frames are ranked according to their blended relative merit values (e.g., worst, second worst, etc.) and the lengths of time for the identified time frames are calculated. At 842, an amount of power that can be discharged during each identified time frame is assigned (time in hours of the time frame window * (i.e., multiplied by) maximum discharging rate of the energy storage device).

At 844, respective discharge instructions are assigned to at least some of the identified time frames based on the rankings associated with the identified times frames until any remaining stored energy of the energy storage device has been fully assigned. In one example, 844 may entail, starting with the highest (e.g., “worst”) blended relative merit value, assigning a discharge instruction to that time frame until the available capacity of the energy storage device has been accounted for.

At 846, a determination is made as to whether the current time frame is within the discharging assignment frame list (i.e., among the list of time frames assigned discharge instructions). If so, the method 800 proceeds to 848 and the energy storage device is instructed to begin discharging with the calculated discharging rate according to the following:

| a. | | While(StorageState_{kWhEnteringFrame} > StorageCapacity_{MinimumDischargeDepth}) | | |
|---|---|---|---|---|
| | | { | | |
| | i. | If the Max Discharge Rate (kW) × the duration of the frame (h) results in a discharge | | |
| | | below the Minimum Discharge Depth (kWh), then the Discharge Rate (kW) assigned | | |
| | | is the highest possible without for that time duration (h) that wouldn't result in a | | |
| | | final state of charge below the Minimum Discharge Depth (kWh). Otherwise, there is | | |
| | | more capacity avialable than can be dscharged in this frame's duration, so the | | |
| | | maximum discharge rate (kW) of this device is assigned for the Discharge Rate (kW). | | |
| | | 1. | if((StorageState_{kWhEnteringFrame} − (DischargeRate_{kW} × TimeDuration_{frame}) < | |
| | | | (StorageCapacity_{MinimumDischargeDepth}) | |
| | | | 1. | { |
| | | | | DischargeRate_{kW} = |
| | | | | $\frac{( {StorageStateKwh}_{EnteringFrame} - {StorageCapacity}_{MinimumDischargeDepth} )}{ChargeRate\_MaxkW}$ |

| | |
|---|---|
| 2. | Else { DishargeRate_{kW} = DischargeRateₘₐₓ} |

| | |
|---|---|
| ii. | DischargeRate_{frame} = DischargeRate_{kW} |
| iii. | StorageState_{kWhExitingFrame} −= DischargeRate_{frame} × TimeDuration_{frame} |
| | } |

If the current time frame is not within the discharging assignment frame list, the method 800 concludes. In some examples, upon a determination that the current time frame is not within the discharging assignment frame list, the energy storage device may remain idle (i.e., neither charge nor discharge) during the current time frame.

In one example, the present disclosure also provides a method for calculating energy storage device capacity availability in Data Centers or other devices. In this example, a method is provided for calculating how much energy storage device capacity is available for charge/discharge monitization or optimization for financial arbitrage, ancillary services, carbon minimization, etc. with respect to the predicted Data Center load, the backup energy storage device capacity availability and it's health, and the amount of time the generators take to provide usable power in the event of a blackout or other power issue

The Data Center load for each upcoming storage window is predicted using a polynomial regression predictive machine learning model trained on historical data, which is used to predict future values using present conditions for this training data. Data Center load is rarely, if ever, 100% of capacity and varies throughout the day and year relatively predictably. Using a predicted Data Center load, rather than simply provisioning for the maximum possible demand liberates the maximum possible capacity for utilization from the energy storage device. The overall aim is identify the exact amount of energy storage device capacity that is surplus to this backup need, to fully optimize it's value.

Utilizing example values for certain variables, the storage capacity available for optimization may be calculated according to the following method:

| i. | | Total Usable Storage Capacity = TotalStorage * |
|---|---|---|
| | | StorageHealth as a function of 100% |
| | 1. | Usable Storage Capacity = 3 MWh * 93% = 2.79 MWh |
| ii. | | Predict the Datacentre Load |
| | 1. | Load_(Datacentre_Predicted) = 68.5 MW |
| iii. | | Reserve Storage Capacity = Predicted Datacentre |
| | | Load x Generator Start and Sync Time |
| | 1. | Sample: Generator Start and Sync Time * Datacentre |
| | | Load: 60 seconds * 68.5 MW = 68.5 MegaWatt |
| | | minutes, which is 1.14 MWh. |
| iv. | | Storage Capacity available for monitisation = Usable |
| | | Storage Capacity-Reserve Storage Capacity |
| | 1. | StorageCapacity Available = 2.79-1.14 = 1.65 MWh |
| | 2. | Miniumum Discharge Level = 1.14 MWh |

According to the foregoing, the output of a sample run produces the following results: (1) 1.65 MWh is assigned for charge/discharge monitisisatin or optimsiation through Ancillary Services and (2) Minimum Discharge Level set to 1.14 MWh.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term memory is a subset of the term computer-readable medium or machine-readable medium. The term computer-readable medium or machine-readable medium, as used herein, does not encompass transitory electrical or electromagnetic signals propagating through a medium (such as on a carrier wave); the term computer-readable medium or machine-readable medium may therefore be considered tangible and non-transitory. Non-limiting examples of a non-transitory, tangible computer-readable medium or machine-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTMLS (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A system comprising:
a processor;
memory; and
a charge adjustment application that is stored in the memory and executed by the processor and that is configured to:
calculate a merit value for a current time frame based on current data concerning one or more predetermined criteria;
calculate respective merit values for one or more future time frames based on the current data and historical data concerning the one or more predetermined criteria;
identify, from among the current time frame and the one or more future time frames, a plurality of candidate charge adjustment time frames, wherein the plurality of candidate charge adjustment time frames comprises a plurality of sequential time frames associated with respective merit values satisfying a threshold merit value; and
assign, from among the plurality of candidate charge adjustment time frames, one or more charge adjustment time frames during which to adjust a charge level of an energy storage device based on at least the merit values associated with the plurality of candidate charge adjustment time frames.

2. The system of claim 1, wherein the charge adjustment application is further configured to:
generate an instruction to adjust the charge level of the energy storage device during the one or more charge adjustment time frames.

3. The system of claim 2, wherein the instruction to adjust the charge level comprises an instruction to charge the energy storage device.

4. The system of claim 2, wherein the instruction to adjust the charge level comprises an instruction to discharge the energy storage device.

5. The system of claim 2, further comprising:
the energy storage device,
wherein the energy storage device is configured to adjust its charge level in response to receiving the instruction.

6. The system of claim 1, wherein the charge adjustment application is configured to assign the one or more charge adjustment time frames by calculating a charge capacity for each of the plurality of candidate charge adjustment time frames based on a length of time associated with each of the plurality of candidate charge adjustment time frames and a charge adjustment speed associated with the energy storage device.

7. The system of claim 1, wherein the charge adjustment application is configured to assign the one or more charge adjustment time frames by ranking the plurality of candidate charge adjustment time frames according to their respective merit values.

8. The system of claim 1, wherein the charge adjustment application is further configured to:
generate an instruction to maintain the charge level of the energy storage device during the current time frame.

9. The system of claim 1, wherein the one or more predetermined criteria comprise a plurality of criterion, each criterion being associated with a different weight.

10. The system of claim 1, wherein the one or more predetermined criteria comprise at least two of the following criteria:
energy cost;
carbon emissions; and
payment for grid services.

11. A method comprising:
calculating a merit value for a current time frame based on current data concerning one or more predetermined criteria;
calculating respective merit values for one or more future time frames based on the current data and historical data concerning the one or more predetermined criteria;
identifying, from among the current time frame and the one or more future time frames, a plurality of candidate charge adjustment time frames, wherein the plurality of candidate charge adjustment time frames comprises a plurality of sequential time frames associated with respective merit values satisfying a threshold merit value;
assigning, from among the plurality of candidate charge adjustment time frames, one or more charge adjustment time frames during which to adjust a charge level of an energy storage device based on at least the merit values associated with the plurality of candidate charge adjustment time frames; and
generating an instruction to adjust the charge level of the energy storage device during the one or more charge adjustment time frames.

12. The method of claim 11, wherein generating the instruction to adjust the charge level comprises generating an instruction to charge the energy storage device.

13. The method of claim 11, wherein generating the instruction to adjust the charge level comprises generating an instruction to discharge the energy storage device.

14. The method of claim 11, further comprising:
adjusting the charge level of the energy storage device during the one or more charge adjustment time frames.

15. The method of claim 11, wherein assigning the one or more charge adjustment time frames comprises:
calculating a charge capacity for each of the one or more charge adjustment time frames based on a length of time associated with each of the plurality of candidate charge adjustment time frames and a charge adjustment speed associated with the energy storage device.

16. The method of claim 11, wherein assigning the one or more charge adjustment time frames comprises:
ranking the plurality of candidate charge adjustment time frames according to their respective merit values.

17. The method of claim 11, further comprising:
generating an instruction to maintain the charge level of the energy storage device during the current time frame.

18. The method of claim 11, wherein the predetermined criteria comprise a plurality of criterion, each criterion being associated with a different weight.

19. The method of claim 11, wherein the predetermined criteria comprise at least two of the following criteria:
energy cost;
carbon emissions; and
payment for grid services.

20. A data center comprising:
a charging window identification module configured to:
identify, from among a current time frame associated with a merit value and one or more future time frames associated with respective one or more merit values, a plurality of candidate charge adjustment time frames, wherein the plurality of candidate charge adjustment time frames comprises a plurality of sequential time frames associated with respective merit values satisfying a threshold merit value;
a charge adjustment time frame assignment module configured to:
assign, from among the plurality of candidate charge adjustment time frames, one or more charge adjustment time frames during which to adjust a charge level of an energy storage device based on at least the merit values associated with the plurality of candidate charge adjustment time frames; and
generate an instruction to adjust the charge level of the energy storage device during the one or more charge adjustment time frames; and
the energy storage device operatively connected to the charge adjustment time frame assignment module, wherein the energy storage device is configured to:
adjust its charge level in response to receiving the instruction.
